(19) United States
(12) Patent Application Publication
(10) Pub. No.: US 2026/0048295 A1
(43) Pub. Date: Feb. 19, 2026

(54) SYSTEM

(71) Applicant: SOFTBANK GROUP CORP., Tokyo (JP)

(72) Inventor: Kuniharu SHIOZAKI, Tokyo (JP)

(73) Assignee: SOFTBANK GROUP CORP., Tokyo (JP)

(21) Appl. No.: 19/299,430

(22) Filed: Aug. 14, 2025

(30) Foreign Application Priority Data
Aug. 16, 2024 (JP) 2024-137084

(51) Int. Cl. A63B 24/00; G06V 40/20

(52) U.S. Cl. CPC A63B 24/0006; A63B 24/0075; G06V 40/23; A63B 2024/0012; A63B 2220/05

(57) ABSTRACT

A system includes a processor that is configured to receive input information including a user's training goal and type of sport, generate a training plan based on the received information, capture and upload a training video of the user performing training according to the training plan, analyze the uploaded training video to identify errors in the user's movements and points for correction, and provide the identified correction points and specific methods for improvement to the user.

### CROSS-REFERENCE TO RELATED APPLICATION

This application is based on and claims priority under 35 USC 119 from Japanese Patent Application No. 2024-137084 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional sports training support systems lack the ability to provide personalized and effective training guidance by comprehensively analyzing an individual user's training goals, movement performance, and the latest professional knowledge. As a result, users often do not receive optimal feedback or training plans tailored to their specific needs, which limits the improvement of their sports skills and training efficiency.

### SUMMARY

The present invention provides a system comprising a processor configured to receive a user's training goal and type of sport, generate a tailored training plan, capture and upload user training videos, analyze the uploaded videos to identify movement errors and correction points, and deliver specific improvement advice to the user. The processor performs frame-by-frame analysis of user movements, compares them against professional performance, and incorporates professional expertise and up-to-date sports theory for training plan optimization, thereby enabling the provision of highly effective and personalized training support.

“Processor” means a central processing unit or microprocessor capable of executing instructions to perform specific computational and control functions within the system.

“Training goal” means an objective or desired achievement specified by the user for improving a particular aspect of physical performance or sports skill.

“Type of sport” means the category or discipline of physical activity or athletic competition selected by the user, such as soccer, basketball, or tennis.

“Training plan” means a structured schedule or program comprising specific exercises, activities, and objectives designed to help the user achieve the specified training goal.

“Training video” means a video recording captured and/or uploaded by the user, showing the user performing training activities according to the training plan.

“Analysis” means the process of examining the uploaded training video to evaluate the user's movements, detect errors, and identify points requiring correction.

“Professional-level performance” means a reference standard of movement or technique based on actions performed by expert athletes or according to recognized expert guidelines in the selected sport.

“Correction points” means specific aspects or elements of the user's movements that require adjustment or improvement to enhance performance or avoid errors.

“Improvement advice” means concrete, actionable suggestions or instructions provided to the user to address identified correction points and improve their training results.

“Professional expertise” means specialized knowledge, skills, or techniques of experienced athletes, coaches, or trainers in the relevant sport.

“Latest sports theory” means up-to-date scientific research, methodologies, and best practices in the field of sports training and performance enhancement.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

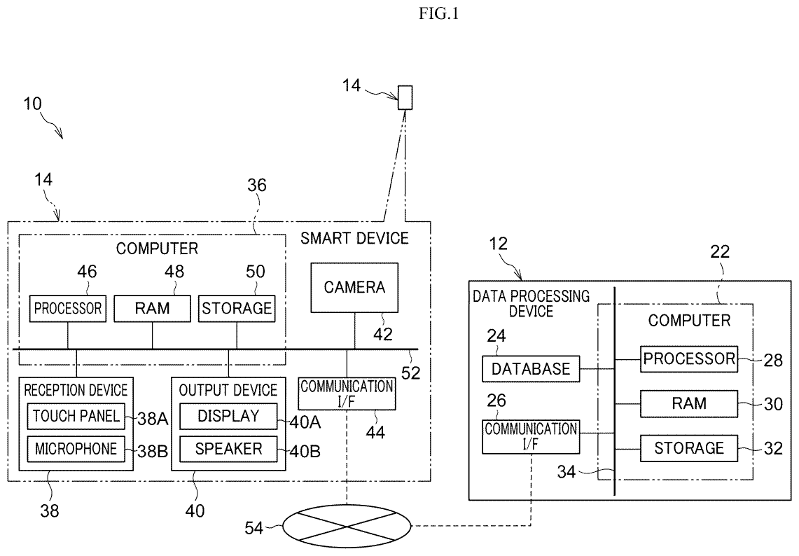

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

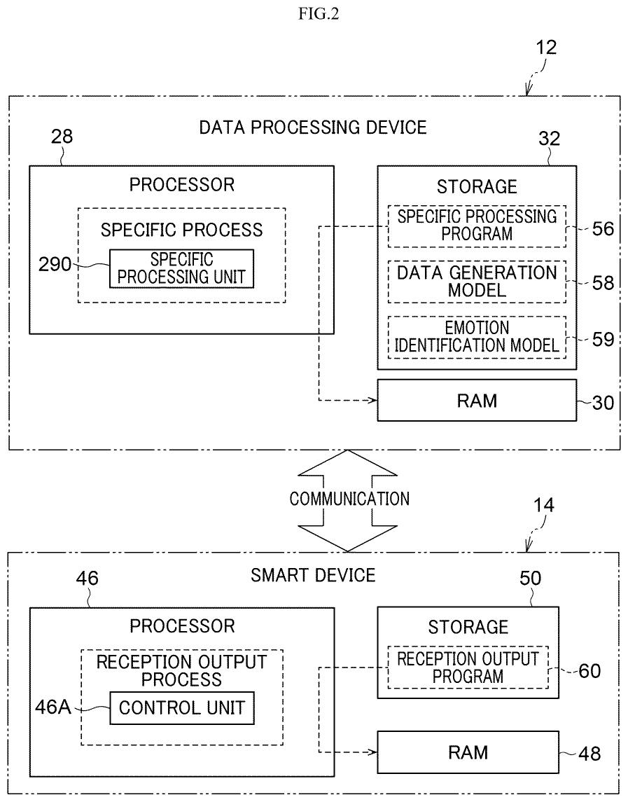

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional sports training support systems are unable to provide highly individualized training plans or deliver precise feedback based on user-specific motions. In particular, existing techniques lack the ability to combine user activity objectives with extensive professional knowledge and the latest sports theories to generate optimized training plans. Furthermore, the analysis of training videos is often generic and cannot accurately identify motion errors or specific correction points for the user. As a result, users are unable to efficiently improve their sports performance in a manner tailored to their unique goals and movement characteristics.

The specific processing by the specific processing unit 290 of the data processing device 12 in Example 1 is realized by the following means.

The present invention provides a server comprising a processor configured to: receive activity objective information and activity type information from a user; generate, utilizing associated knowledge information and a generative artificial intelligence model, an instruction sentence and an optimized training plan; obtain and analyze motion video information using image recognition and deep learning processes to extract user feature information and identify motion errors and correction points by comparison with reference information; and deliver specific feedback including visual annotations and replay of relevant video sections to the user. This enables precise generation of customized training plans and accurate feedback tailored to each user's individual objectives and actual performance, thereby substantially improving the effectiveness and efficiency of sports training.

The term “activity objective information” refers to information indicating a user's specific training goal or desired achievement in a particular activity or exercise.

The term “activity type information” refers to information specifying the category, sport, or form of movement that the user intends to perform or train in.

The term “information input unit” refers to a device or interface, such as a graphical user interface on a computing device, which allows a user to enter activity objective information and activity type information.

The term “knowledge information” refers to information and data representing accumulated know-how, professional expertise, and established theories about activities, movements, or sports.

The term “instruction sentence” refers to a textual command or prompt generated for input into a generative artificial intelligence model, directing the model to create a suitable training plan.

The term “generative artificial intelligence model” refers to an artificial intelligence system that is capable of generating outputs, such as training plans or analyses, in response to textual instruction sentences or prompts.

The term “training plan information” refers to structured information outlining a schedule, set of exercises, or progression plan intended to help a user achieve their activity objective.

The term “motion video information” refers to digital video data capturing a user's performance of an exercise or activity, which may be recorded and transmitted for analysis. The term “video capturing and transmission unit” refers to functional components or systems that record motion video information of the user and transmit it to a processor or server.

The term “image recognition process” refers to computerized processing for analyzing images or video frames in order to detect and identify specific features or movements.

The term “deep learning process” refers to computational processing utilizing multi-layered machine learning models to analyze, interpret, or classify features within video or image data.

The term “user feature information” refers to data elements representing characteristics, biomechanics, or movement metrics specific to an individual user extracted from motion video information.

The term “reference information” refers to standard or benchmark data, such as examples of ideal performance, against which a user's feature information is compared.

The term “motion errors” refers to deviations or mistakes in a user's movement when compared to reference information or an ideal model.

The term “correction points” refers to specific aspects or segments of a user's movement that are identified as needing improvement based on analysis of motion video information.

The term “communication unit” refers to a functional component that transmits information, including feedback, between the processor and the user.

The term “feedback” refers to information or guidance provided to the user based on analysis, which may include advice, visual annotations, and replay of relevant sections of motion video information.

The term “visual annotations” refers to graphical elements superimposed on video or images in order to highlight or illustrate specific findings, errors, or correction points.

The present invention can be implemented by configuring a system comprised of a server including a processor, one or more user terminals such as smartphones or tablets, and communication means for data exchange between the server and the terminals.

The server is equipped with computing hardware such as a central processing unit and graphics processing units (for example, general-purpose GPU servers). The server operates software components including a backend framework (for example, a Python-based web server such as FastAPI or Flask), a relational database (for example, PostgreSQL), an image recognition and video analysis library (for example, OpenCV, TensorFlow, or PyTorch), and an interface to a generative artificial intelligence model, which may be implemented using a cloud-based large language model service or an internally hosted model.

Each terminal is, for example, a mobile device including a user interface generated by a dedicated application. The application may be developed for general-purpose mobile operating systems such as Android or iOS. The terminal provides screens that allow the user to enter activity objective information, such as their training goals, and activity type information, such as the sport or type of movement to be trained.

To use the system, the user launches the application on their terminal and enters their desired activity objective and activity type—for example, entering “improve free kick accuracy in soccer.” The terminal converts these inputs to structured data and communicates them securely to the server over HTTPS.

Upon receiving user input, the server accesses knowledge information stored in its database, representing professional expertise and sports science principles. The server generates an instruction sentence, or prompt sentence, which constitutes a text command for input to the generative artificial intelligence model. For example, the server forms the following prompt:
“Please generate a training plan to improve free kick skills for soccer. The user's goal is to achieve highly accurate free kicks. Include a detailed training schedule, concrete exercises, and objectives for each training step.”

The server submits the prompt to the generative AI model by API call. The AI model responds with a training plan, which may specify a weekly schedule, daily exercises, and objectives for each step. The server parses and organizes the training plan and sends it back to the user's terminal, where it is displayed through the application interface.

At any stage, the user may record a video of themselves performing the prescribed exercises, using the terminal's native video recording capabilities via the application. The terminal compresses the recorded video, appends identifying metadata (such as a timestamp and user ID), and uploads it to the server through a secure connection.

The server receives the motion video information, extracts frames, and applies image recognition and deep learning algorithms to identify user feature information, such as joint positions and movement trajectories. The server compares extracted features with reference information, such as ideal movement data from professional athletes. By analyzing frame-by-frame deviations, the server identifies motion errors and correction points specific to the user. The server generates visual annotations highlighting errors and attaches them to the relevant video segments.

Feedback information, including correction points, improvement advice, and links to replay annotated video sections, is transmitted from the server to the terminal. The terminal displays this feedback within the application dashboard, often by overlaying visual markers on video frames and presenting bullet-point guidance for improvement.

This system is distinguished by its ability to tailor training plans and feedback through integration of knowledge information and user-specific activity objective data, utilization of generative artificial intelligence models for plan creation, and precise analysis of user movement through advanced image recognition and deep learning techniques.

For example, a user seeking to improve their soccer free kick can input this goal, receive a scientifically constructed training plan, record their kicking technique, and receive detailed, individualized guidance based on comparison with expert performance. The following is an example of a prompt sentence generated in this system:
“Please generate a training plan to improve free kick skills for soccer. The user's goal is to achieve highly accurate free kicks. Include a detailed training schedule, concrete exercises, and objectives for each training step.”

In this manner, the invention can be implemented by using combinations of general-purpose computational hardware and widely used software frameworks, along with connection to a generative AI model, to provide users with continuously personalized, expert-guided sports training support.

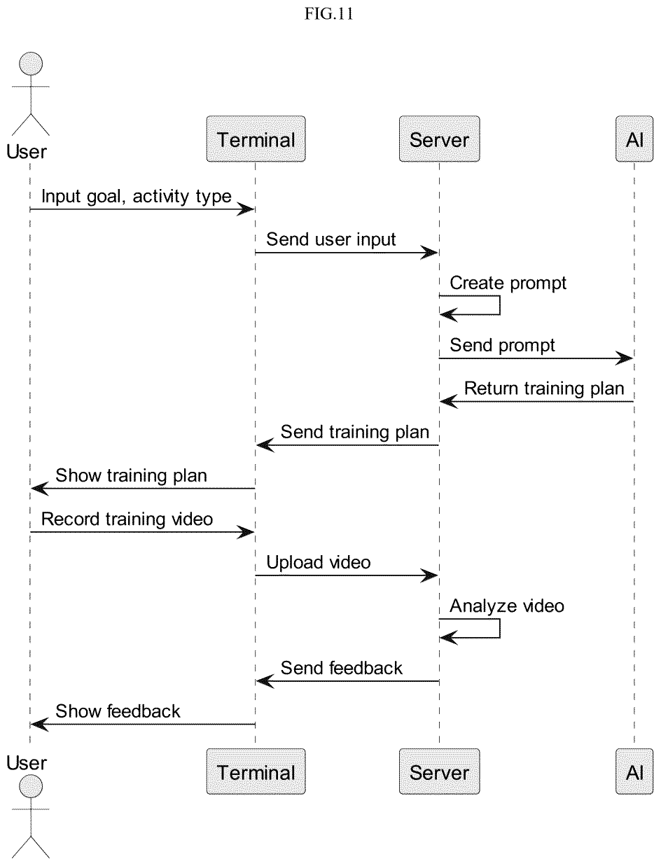

The following describes the processing flow using FIG. 11.

### Step 1:

Terminal displays an input form on the user interface, prompting the user to enter activity objective information and activity type information. User selects or enters their specific training goal (for example, “improve free kick accuracy”) and selects the activity type (for example, “soccer”). The terminal converts this input into a structured data object, such as JSON, and transmits it to the server via HTTPS.

Input: User's manually entered or selected training goal and activity type.

Processing: Terminal converts raw user input into structured data.

Output: Structured activity objective and activity type data transmitted to the server.

### Step 2:

Server receives structured user input through a secure API endpoint. Server parses the incoming data and validates its completeness and correctness. Server retrieves relevant knowledge information from a database, such as professional training practices and theoretical data related to the specified activity type and goal. Server then programmatically generates a prompt sentence by combining data from both the user input and the knowledge database.

Input: Structured activity objective and activity type data from terminal.

Processing: Server queries knowledge database, combines data into a natural language prompt sentence.

Output: Prompt sentence for generative AI model.

### Step 3:

Server sends the generated prompt sentence to a generative AI model via API call, providing authentication tokens as needed. Server receives, in response, training plan information structured as text or JSON from the generative AI model. Server parses, processes, and organizes this data to create a user-tailored training plan.

Input: Prompt sentence for generative AI model.

Processing: Server formats and submits prompt to AI, receives and processes AI-generated training plan.

Output: Parsed and organized training plan information.

### Step 4:

Server transmits the training plan information to the terminal over the network. Terminal receives the training plan and renders the schedule, step-by-step exercises, and objectives on the application dashboard for user viewing. The application also sets reminders or checklists for the suggested training steps.

Input: Parsed and organized training plan information from server.

Processing: Terminal decodes and displays the plan through graphical interface elements.

Output: Interactive and viewable training plan for the user on the terminal.

### Step 5:

User performs training based on the displayed plan. User uses the terminal's built-in camera feature, triggered from within the app, to record a video of their own exercise or movement as specified in the plan.

Input: Training instructions and exercises from the displayed plan.

Processing: User physically enacts the training and records video.

Output: Motion video file stored on the terminal.

### Step 6:

Terminal compresses the recorded motion video using a video processing library, attaches a timestamp and user identifier to the file metadata, and prepares an upload request. Terminal uploads the video file to the server via a secure multipart POST method.

Input: Motion video file recorded by the user.

Processing: Terminal compresses, attaches metadata, and uploads the video.

Output: Motion video information transmitted to the server.

### Step 7:

Server receives the uploaded motion video file and stores it in a designated directory. Server extracts individual frames from the video using an image recognition library, and applies a deep learning model to analyze user movement. Server processes the frames to extract user feature information, such as body joint positions and movement trajectories. Server compares these features to stored reference information representing ideal movements or professional performance. Server calculates deviation metrics, identifies motion errors, and determines specific correction points.

Input: Motion video information from terminal.

Processing: Server extracts frames, applies deep learning, compares user features with reference, calculates deviations, identifies errors and correction points.

Output: Error analysis data and correction point information.

### Step 8:

Server generates a feedback report, formulating clear advice and improvement suggestions based on detected motion errors and correction points. Server creates visual annotations for relevant sections of the video and prepares replay links to corresponding timestamps. Server transmits the feedback report, including textual guidance and visual overlays, to the terminal for user review.

Input: Error analysis data and correction point information.

Processing: Server converts findings into actionable advice and annotates video segments.

Output: Feedback report with improvement suggestions and annotated video links.

### Step 9:

Terminal receives the feedback report and presents it to the user on the application dashboard. Feedback includes bullet-point advice, video playback controls for annotated sections, and visual overlays highlighting motion errors and correction points. User reviews the feedback, watches the annotations, and prepares for the next training cycle with improved understanding of necessary corrections.

Input: Feedback report with annotated video and advice.

Processing: Terminal renders feedback visually and controls video playback to annotated timestamps.

Output: User interface presenting actionable, individualized feedback for further training.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional training and skill improvement systems for tasks such as industrial operations or sports, it is necessary for users to possess specialized knowledge and experience in order to efficiently refine their techniques. Furthermore, there is a lack of effective solutions for quickly and precisely identifying errors and improvement points, resulting in decreased training efficiency and potentially slow progress. Additionally, existing systems do not fully utilize advanced artificial intelligence and interactive feedback mechanisms to optimize the training process for each individual. Therefore, there is a strong need for a solution that can automate the generation of customized training plans, objectively analyze recorded video data, and provide targeted feedback to accelerate skill acquisition and performance improvement, while utilizing accumulated knowledge and up-to-date theory.

The specific processing by the specific processing unit 290 of the data processing device 12 in Application Example 1 is realized by the following means.

The present invention provides a server comprising a processor configured to acquire user input regarding training objectives and task content, generate a training activity plan utilizing a generative artificial intelligence model, receive and analyze user-recorded video data of operational activities with both an image analysis device and the generative artificial intelligence model to sequentially identify errors and correction points, and present the identified errors and corresponding improvement instructions to the user. This enables automated, objective, and individualized training plan generation and feedback provision based on video analysis and accumulated knowledge, thereby enhancing the efficiency and effectiveness of skill improvement for each user.

The term “processor” refers to a hardware or software-based data processing unit capable of executing instructions and performing operations required for data acquisition, analysis, and control within the system.

The term “generative artificial intelligence model” refers to an artificial intelligence algorithm or framework that is capable of producing new data, plans, or responses based on learned patterns and input information, such as a text, image, or video prompt.

The term “training activity plan” refers to a structured sequence of actions, exercises, or instructions formulated to facilitate the improvement of a user's skills or performance in a particular task or operation.

The term “video data” refers to a digital recording of visual information captured during a user's operational activity or training session, which can be processed and analyzed by computational means.

The term “task content” refers to the specific nature and description of the activity, operation, or procedure that is to be performed or practiced by the user.

The term “image analysis device” refers to a hardware or software component for processing, extracting, and interpreting information from video or image data in order to evaluate the user's actions.

The term “correction point” refers to a specific aspect or detail in the user's behavior or performance that is identified as requiring modification or improvement in order to approach an optimal or standard level.

The term “improvement method” refers to a concrete, actionable recommendation or set of instructions provided to the user for addressing an identified error or correction point. The term “knowledge data” refers to accumulated information, expertise, and historical records relevant to the training domain, which can be used as a reference for evaluating and optimizing user performance.

The term “theoretical information” refers to the latest principles, models, or scientific findings related to the domain of training, which are used to inform and improve the generation of training activity plans.

The system comprises a server, one or more terminals, and user-operated devices. The server includes a processor that is configured to perform acquiring user input, generating training activity plans using a generative artificial intelligence model, receiving and analyzing video data, and providing personalized feedback. Typical examples of the generative artificial intelligence model include large language models and vision-language models installed as local software or provided via a cloud-based API. Specific examples of such models may include but are not limited to commercially available generative artificial intelligence models and frameworks. The server may use a database management system, such as a relational or non-relational database, to store user history, training data, and knowledge data.

A terminal may be a general-purpose information processing device such as a smartphone, tablet computer, or personal computer on which a dedicated application or web interface operates. The terminal includes a user interface or input device, such as a touch panel, camera, and display. Each user launches the application on the terminal, and is prompted to enter information such as a training objective and task content. For example, the user may input “improve welding accuracy” (as a training goal) and “welding” (as a task) using a form on the terminal.

The terminal transmits the entered data to the server via secure network communication protocols (such as HTTPS). The processor on the server receives the data and queries stored training knowledge and theoretical information. The processor prepares a prompt sentence based on the input and utilizes the generative artificial intelligence model to generate a tailored training activity plan. The training activity plan may include a schedule, suggested practice sessions, technical checkpoints, and milestone goals.

A typical prompt sentence to generate a training plan may be as follows:

“Please create a training plan to improve robot welding accuracy for a beginner. Include a stepwise schedule, advice for fundamental techniques, and specific evaluation criteria for each step.”

After generating the plan, the server transmits it to the user's terminal, which displays it on its dashboard. The user performs the prescribed training according to the plan, using the terminal's camera to record their training performance or operation process as video data. The terminal provides a video upload interface so that the user can upload the recorded file to the server.

Upon reception of the video data, the processor on the server uses an image analysis device, such as a software framework for analyzing visual content (e.g., OpenCV or other image analysis libraries), to extract time-series metrics of the user's movement or task execution. The processor composes a specific prompt sentence with the analyzed metrics and provides it to the generative artificial intelligence model to obtain an expert assessment. The server identifies errors or points of needed correction by comparison against standard operation criteria or professional benchmarks, and further generates concrete improvement instructions.

An example of a prompt sentence used for feedback generation may be:

“Analyze this welding training video and determine key errors such as improper arm speed or bead misalignment. Based on professional standards, provide specific, actionable improvement instructions.”

The server transmits the resultant feedback, including identified correction points and recommended improvement methods, to the user's terminal. The terminal displays the feedback to the user in a user-friendly format, allowing the user to modify their future practice accordingly.

Optionally, the server may further analyze facial expressions or audio characteristics from the video using emotion recognition functions, and adjust the feedback tone or content based on the user's detected emotional state.

This embodiment allows the system to automate customized training plan generation, objective video analysis, and individualized feedback provision by efficiently combining user interface devices, communications technology, video analysis algorithms, and generative artificial intelligence models. The use of generative AI enables the system to flexibly generate training plans and feedback for a wide range of tasks and user skill levels, utilizing accumulated knowledge data and the latest theoretical information. By repeating cycles of practice, recording, analysis, and feedback, the user's skill improvement is accelerated objectively and efficiently.

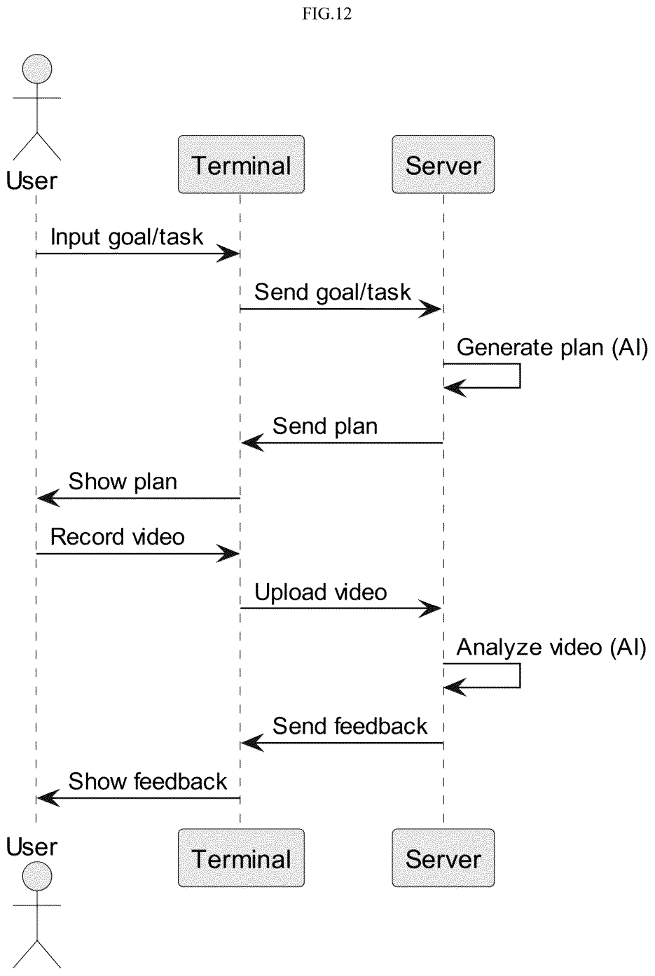

The following describes the processing flow using FIG. 12.

### Step 1:

User launches the dedicated application on the terminal and inputs the training objective and task content into an on-screen form. The input consists of specific text data, such as “improve welding accuracy” and “welding.” Terminal receives this user input and outputs a structured data package containing the training objective and task content.

### Step 2:

Terminal transmits the structured data package to the server over a secure network connection. The input for the server is the structured data package containing the user-inputted training objective and task content. Server parses the received data and outputs the extracted values for further processing.

### Step 3:

Server queries its internal database or external knowledge resources using the extracted training objective and task content as keys. Server processes this input by identifying and retrieving relevant knowledge data and theoretical information, and outputs a compiled dataset of reference information.

### Step 4:

Server constructs a prompt sentence using the extracted values and the compiled dataset, such as: “Create a training plan to improve welding accuracy for a beginner operator based on best practices and professional guidelines.” The input is the combination of user-provided data and reference information; the output is a text prompt tailored for the generative AI model.

### Step 5:

Server provides the prompt sentence to the generative AI model. The generative AI model takes the prompt sentence as input, performs language generation, and outputs a customized training activity plan, which may include a timeline, specific exercises, and target milestones.

### Step 6:

Server receives the generated training activity plan and encapsulates it as a data object. Server transmits this data object to the terminal. The input in this step is the generated plan text; the output is the data object ready for user display.

### Step 7:

Terminal displays the received training activity plan on the application interface. User reviews the training plan and follows the given instructions. The input for this step is the plan data from the server, and the output is the visual presentation of the plan on the device.

### Step 8:

User performs the training activity according to the plan while recording their operation using the terminal's camera function. The input is the real-world training operation and the output is the digital video file recorded by the terminal.

### Step 9:

Terminal prompts the user to upload the recorded video. Terminal takes the recorded video file as input and outputs an upload request containing the video data, which is sent to the server.

### Step 10:

Server receives the uploaded video file. Server applies image analysis software to the video data, processes the input by extracting motion features frame by frame, and compares these features with professional benchmarks. The output consists of detected errors, operation metrics, and identified correction points.

### Step 11:

Server formulates a prompt sentence including the extracted errors and metrics, such as: “Analyze the following operation data: inconsistent arm speed, deviation from straight bead path. Provide concrete recommendations for improvement.” The input is the set of video-derived metrics; the output is a tailored prompt for the generative AI model.

### Step 12:

Server inputs the tailored prompt into the generative AI model. The model processes the input and outputs specific feedback messages recommending improvement actions and concrete advice for the user.

### Step 13:

Server receives the feedback message and transmits it to the terminal. The input is the feedback text, and the output is a data message addressed to the terminal for user consumption.

### Step 14:

Terminal displays the feedback and recommended improvements to the user, highlighting key correction points and actionable guidance. The input is the feedback data from the server; the output is the visual presentation to the user on the terminal's interface.

### Step 15:

User reviews the feedback, adjusts future practice accordingly, and may repeat the process by returning to a prior step, thus forming a closed feedback loop for continuous improvement. The input is the feedback and improvement instructions; the output is the subsequent change in user behavior and new training sessions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional training support systems for physical activities or sports focus on analyzing a user's movements and suggesting improvements but lack consideration of the user's emotional state during feedback. This one-sided and non-adaptive approach may result in suboptimal training efficiency and reduce the user's motivation. Moreover, there is a need for a system that can provide feedback tailored not only to technical performance but also to the subject's psychological condition, allowing for continuous and effective improvement in training quality and user engagement.

The specific processing by the specific processing unit 290 of the data processing device 12 in Example 2 is realized by the following means.

The present invention provides a server comprising a processor configured to obtain objective and category information from a subject, generate a support plan using a generative artificial intelligence model and internal prompt sentence, receive and analyze transmitted activity video information to extract correction points, present improvement methods to the subject, and recognize the emotional state of the subject to adjust the feedback accordingly. This enables the system to provide highly personalized and emotionally adaptive feedback, thereby improving training efficiency, user satisfaction, and performance outcomes.

The term “objective information” refers to data representing the goals, intentions, or desired outcomes specified by a subject, which are used for generating personalized training or support plans.

The term “category information” refers to classification data that identifies the type or nature of an activity, such as the specific field, sport, or area in which the subject seeks improvement.

The term “information acquisition unit” refers to a hardware or software component that collects or receives input data from a subject, including but not limited to user interfaces, sensors, or network modules.

The term “plan generation unit” refers to a hardware or software component that creates a support plan or training regimen based on input data, utilizing algorithms, artificial intelligence models, or knowledge databases.

The term “video transmission unit” refers to a hardware or software component enabling the recording and transmission of video information from a subject to a processing server.

The term “information processing apparatus” refers to computing hardware or a system configured to execute analysis, data processing, or computational tasks on received input data.

The term “analysis unit” refers to a hardware or software module that processes video information to identify improper aspects and correction points of activities performed by the subject.

The term “improper aspects” refers to identifiable errors, deviations, or inefficiencies in the subject's activity as determined by analysis in relation to established reference standards.

The term “correction points” refers to specific elements or stages within an activity where modifications or improvements are required based on analysis results.

The term “information presentation unit” refers to a hardware or software mechanism designed to deliver feedback, guidance, or support information—such as correction points and improvement methods—to the subject.

The term “emotion recognition and adjustment unit” refers to a hardware or software component that detects the emotional state of the subject using input signals (such as facial expression, voice, or body posture), and adjusts feedback or content accordingly.

The term “generative artificial intelligence model” refers to a machine learning model capable of producing training plans, advice, or content dynamically in response to user input and contextual data, such as a language model or deep neural network.

The term “internal prompt sentence” refers to a structured, context-aware instruction formulated for input into an artificial intelligence model, guiding the model to generate relevant and customized outputs.

One embodiment of the present invention is implemented as a computer-implemented sports or activity support system comprising a server and at least one terminal device connected via a communication network. The terminal may be realized by a generic computing device such as a smartphone, tablet, or personal computer, equipped with a camera, microphone, and appropriate user interface modules. The server is preferably constituted by a high-performance computing device capable of executing artificial intelligence-based algorithms, storing and manipulating data, and performing real-time communications with terminals.

The terminal functions as the information acquisition unit, through which the user is prompted to input objective information (such as training goals or desired outcomes) and category information (such as the type of sport or activity category). The terminal transmits these inputs, formatted according to a predefined data structure (such as JSON), to the server through secure network communication protocols (e.g., HTTPS).

The server acts as the plan generation unit. Upon reception of the input data, the server accesses stored information resources, including knowledge databases and theoretical information relevant to the selected category, and utilizes a generative artificial intelligence model to create a support plan tailored to the user's inputs. The generative AI model may be realized by a language model or neural network architecture, such as a large language model, trained to interpret internal prompt sentences structured based on the input data. For example, an internal prompt sentence may be:

“Generate a 3-week football training plan for improving free-kick accuracy for an intermediate user.”

After generating the support plan, the server sends the plan to the terminal, where it is displayed to the user. The terminal also provides instructions for recording activity video data in accordance with the plan's content. The user uses the terminal's camera to record their training or activity session and, after reviewing and confirming the recording, uploads the video file to the server via the video transmission unit.

The server, functioning as the information processing apparatus and analysis unit, processes the received video using software tools such as OpenCV (for frame extraction), OpenPose (for pose estimation), or equivalent modules capable of detecting and analyzing body motion. The server identifies improper aspects (such as misalignments, incorrect movement patterns, or timing errors) and extracts correction points by comparing the user's movement data to reference standards stored in the database.

The server further operates as the emotion recognition and adjustment unit. It employs emotion recognition algorithms to analyze the user's emotional state, making use of facial analysis software, voice tone analysis modules (such as DeepSpeech), and gesture analysis engines. Based on the detected emotional state, the server adapts the generated feedback. For instance, if the user's facial expression and tone suggest anxiety, the server modifies the feedback to include supportive language and relaxation advice.

The information presentation unit on the terminal receives the server's feedback, including extracted correction points and improvement recommendations, and displays them to the user using a user-friendly graphical interface. Information may be presented as textual feedback, annotated visual overlays on video, or as step-by-step improvement suggestions. The user may then implement the provided feedback in their next training session, promoting a cycle of continuous improvement.

A concrete example of system operation is as follows:

The user opens the dedicated application on a smartphone, selects “football” as the activity category, and sets “improve free-kick accuracy” as the objective. This data is transmitted to the server, which responds with a customized three-week training plan. The user practices the free-kick drills, records their actions on the terminal, and uploads the video to the server. The server analyzes the video, detects that the supporting foot placement is suboptimal, and also determines from facial expressions that the user is nervous. Feedback is therefore modified to include both a detailed correction (“place supporting foot closer to the ball”) and supportive advice (“Relax your shoulders before you take your shot”). The user receives this information via the terminal's display and adapts their practice accordingly.

Example prompt sentences used for the generative AI model may include:

“Analyze the uploaded football free-kick video. Identify technical errors and suggest concrete corrections. If the user appears nervous based on facial expression or voice, also add supportive and calming advice to the feedback.”

“Generate a 3-week customizable football free-kick training plan for a user aiming to improve accuracy. Include specific drills, schedules, and checkpoints.”

Through these means, the invention provides a highly adaptive, individualized support system for skill acquisition and performance improvement in sports and similar domains, leveraging advanced data analysis and generative artificial intelligence.

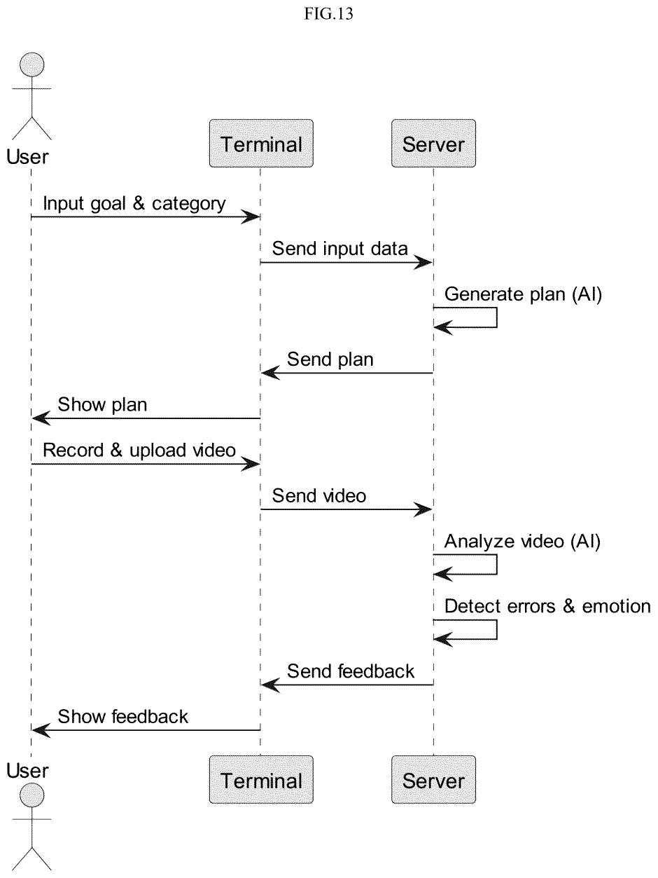

The following describes the processing flow using FIG. 13.

### Step 1:

The terminal displays a user interface prompting the user to input their training objective and the category of activity (for example, “improve free-kick accuracy” and “football”). The user inputs the required information and presses a submit button. The terminal collects this input, formats it into a standardized data packet (for example, as a JSON object), and transmits it to the server using a secure transmission protocol.

Input: User's objective and activity category entered via the application interface.

Data processing: The terminal encodes and formats the data, generating a structured request.

Output: A formatted data packet carrying the user's objective and category sent to the server.

### Step 2:

The server receives the formatted input data from the terminal and parses it to extract the user's objective and activity category. The server retrieves reference information and theoretical knowledge from its stored data resources according to the activity category. The server then generates an internal prompt sentence and supplies the parsed data and relevant context to the generative AI model in order to create a customized support plan for the user.

Input: Formatted data packet containing the user's objective and category.

Data processing: The server parses the packet, retrieves related reference data, constructs an internal prompt for the generative AI model, and generates a support plan.

Output: A customized support plan for the user, returned to the terminal.

### Step 3:

The terminal receives the support plan and presents it through the user interface. The terminal instructs the user to record activity content according to the supplied plan. The user uses the terminal's camera module to record a training session. The terminal saves the video file, prompts the user to confirm or review the recording, and, on approval, encodes the video (e.g., to mp4) and securely uploads it to the server using a file transfer protocol.

Input: Support plan and user's newly recorded video file.

Data processing: The terminal encodes and compresses the video file, gathers necessary session metadata, and initiates secure upload to the server.

Output: A packaged video recording and metadata submitted to the server.

### Step 4:

The server receives the uploaded activity video and stores it in a processing directory. The server extracts video frames using a video processing library (such as OpenCV) and conducts pose or motion analysis using models (such as OpenPose or an equivalent neural network). The server compares extracted movement data to reference standards and identifies errors or inefficient patterns, extracting specific correction points.

Input: Uploaded video file containing user's training activity.

Data processing: The server splits the video into frames, estimates pose/motion parameters, compares movements with reference standards, and determines improper aspects and correction points.

Output: A set of identified errors, correction points, and improvement data.

### Step 5:

The server applies emotion recognition algorithms to the video, analyzing facial features, body language, and (if available) voice audio using specialized modules (for example, facial analysis and speech analysis software). The server determines the user's emotional state. Based on this information and the identified correction points, the server constructs a prompt sentence and instructs the generative AI model to create emotionally adaptive feedback.

Input: Video frames, facial/body/voice data, identified movement errors, and correction points.

Data processing: The server processes emotion-related signals, determines the user's emotional state, creates an adapted prompt for the generative AI, and generates feedback with both correction instructions and emotional support as appropriate.

Output: Feedback text and improvement suggestions, customized to the user's emotional state and errors.

### Step 6:

The terminal receives the feedback (including error highlights, correction points, and emotional support) from the server. The terminal presents the feedback to the user via the application, using a graphical interface that may show text messages, annotated video segments, or visual cues. The user can review the feedback, play back sections of the video with overlayed corrections, and read or listen to specific suggestions.

Input: Feedback data package received from the server.

Data processing: The terminal prepares and displays the feedback using interface modules according to the type of content supplied.

Output: Comprehensive feedback presented to the user for review and implementation in subsequent training sessions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional training support systems for users, such as robot operators or athletes, primarily focus on analyzing user motions and providing uniform feedback regardless of the user's emotional state. This often results in insufficient motivation, lack of personalized feedback, and reduced continuity in training. Additionally, existing systems rarely offer real-time adaptation of training plans or feedback according to individual skill progress or emotional condition, making it difficult to maximize training efficiency and maintain engagement over time.

The specific processing by the specific processing unit 290 of the data processing device 12 in Application Example 2 is realized by the following means.

The present invention provides a server comprising a processor configured to receive user training goals and classification information, generate a training plan using a generative information processing model, receive and analyze user-recorded training content by comparing it with reference data to identify errors and corrective points, and provide dynamically adjusted feedback and improvement suggestions by detecting and responding to the user's emotional state. This enables a personalized and adaptive training environment that not only addresses technical aspects of the user's training but also supports sustained motivation and higher efficiency by tailoring feedback and training plans according to both individual performance and real-time emotional condition.

The term “information input device” refers to an apparatus or interface that allows a user to enter training goals, classification information, or other relevant data into the system. The term “generative information processing model” refers to a machine learning or artificial intelligence model capable of automatically generating training plans or recommendations based on received user information and context.

The term “generation instruction sentence” refers to a textual prompt or command automatically created by the system to initiate or guide content generation by the generative information processing model.

The term “image information recording and transfer device” refers to a device or function that enables a user to record video or image data of their training activities and transmit that data to the server or processor.

The term “reference recorded content” refers to standard, benchmark, or exemplary motion data stored by the system, which is used for comparative analysis with user-performed activities.

The term “motion analysis” refers to a process of automatically extracting, processing, and interpreting motion data from recorded or real-time images or videos to assess user performance.

The term “operation error locations” refers to specific points or intervals in a user's activity where deviations or mistakes from the reference recorded content are detected.

The term “correction candidates” refers to suggested actions or modifications intended to address and improve detected operation errors.

The term “emotional state” refers to the psychological or affective condition of a user, such as frustration, confidence, or nervousness, detected through analysis of facial expressions, voice, body language, or other indicators.

The term “dynamically adjusting” refers to the process of modifying system output or interaction in real time based on continually updated user-specific data, including emotional state and performance history.

The term “professional knowledge base” refers to a collection of domain-specific expertise, techniques, and principles stored within the system to inform and optimize training plans.

The term “up-to-date theory information” refers to the latest advancements, findings, or validated methodologies relevant to the user's field or training subject, which are used by the system to enhance planning and feedback.

The term “user response history” refers to a record of a user's previous interactions, performance data, and feedback responses, maintained by the system for reference in future analyses or personalized plan adjustments.

An embodiment for implementing the present invention will now be described. The invention may be practiced by constructing an information processing system comprising a server equipped with a processor, one or more user terminals (such as smartphones or tablets), and communication means for exchanging data between the server and the terminals.

The user terminal includes an information input device, which can be realized by a graphical user interface running on a general-purpose operating system such as iOS or Android. The user terminal enables the user to enter training goals and classification information, for example, by selecting options from drop-down menus or by manually entering keywords into text fields.

The terminal is further equipped with an image information recording and transfer device, such as the built-in camera and dedicated application software. This enables the user to record video of their training activities and transmit the video files and relevant metadata to the server over a secure communication protocol such as HTTPS.

The server includes a processor that may be a general-purpose microprocessor or a data processing device equipped with one or more graphics processing units (GPUs) capable of accelerating machine learning tasks. An example server hardware configuration may include a server running a Linux-based operating system, with an NVIDIA GPU for high-performance inference.

On the software side, the server utilizes a generative information processing model, which may be implemented using a machine learning framework such as PyTorch or TensorFlow. The generative model may be realized by a large language model, for example, GPT-4 or an equivalent locally-hosted neural network model.

When the server receives user training goals and classification information, the processor constructs a generation instruction sentence, known as a prompt, tailored to the user's submission. For instance, a typical prompt sentence may be: “Generate a detailed robot operation training plan for a factory operator aiming to increase efficiency. Please include stepwise feedback and advice to enhance motivation and reduce stress.”

The server uses the generative AI model to generate a personalized training plan for the user. The plan includes a schedule, recommended exercises, and performance targets. The server may retrieve and incorporate reference data from a professional knowledge base and up-to-date theory information stored in a relational database system such as PostgreSQL.

When the user has performed the assigned tasks, the terminal records a video capturing the user's activity and uploads the video to the server. The server then automatically analyzes the received video using an automated motion analysis engine, for example, via OpenCV and a computer vision action recognition model built with PyTorch. Each frame of the video is compared with reference recorded content held in the system's database. The system identifies operation error locations (such as deviations in motion or timing) and correction candidates.

Additionally, the server incorporates an emotion recognition module. This module may utilize software such as MediaPipe for facial analysis and an audio feature extractor to analyze voice tone and body language for emotional cues. The server evaluates the emotional state of the user, for example, classifying it as frustration, confidence, or nervousness.

The server dynamically adjusts the content and tone of the improvement suggestions based on the user's detected emotional state. For example, if the server determines that the user is frustrated, the generated feedback may include encouraging language and relaxation advice in addition to technical corrections.

The feedback, which includes the identified correction candidates, specific improvement suggestions, and motivational advice, is transmitted back to the user's terminal. The terminal displays this information through the application interface, allowing the user to review and apply the feedback in subsequent training sessions.

As a specific example, when a user uploads a video of performing a robot operation task under the goal “efficiency improvement,” the server may detect that the motion is too slow at a certain point and that the user's facial expression indicates frustration. The prompt sentence delivered to the generative AI model by the server could be:

“Give stepwise feedback to correct slow arm movement and suggest calming advice for user frustration.”

The generative AI model responds with tailored feedback, such as: “To improve efficiency, try to move the robot arm smoothly and avoid pauses. If you feel frustrated, take a short break, breathe deeply, and remember that progress is gradual.”

The claimed invention may be implemented using commercially available hardware and open-source or proprietary software platforms. The modular structure allows for adaptation and extension to various fields beyond robotics, such as sports or rehabilitation training, by customizing the knowledge base, prompt formulation logic, and analysis modules as required.

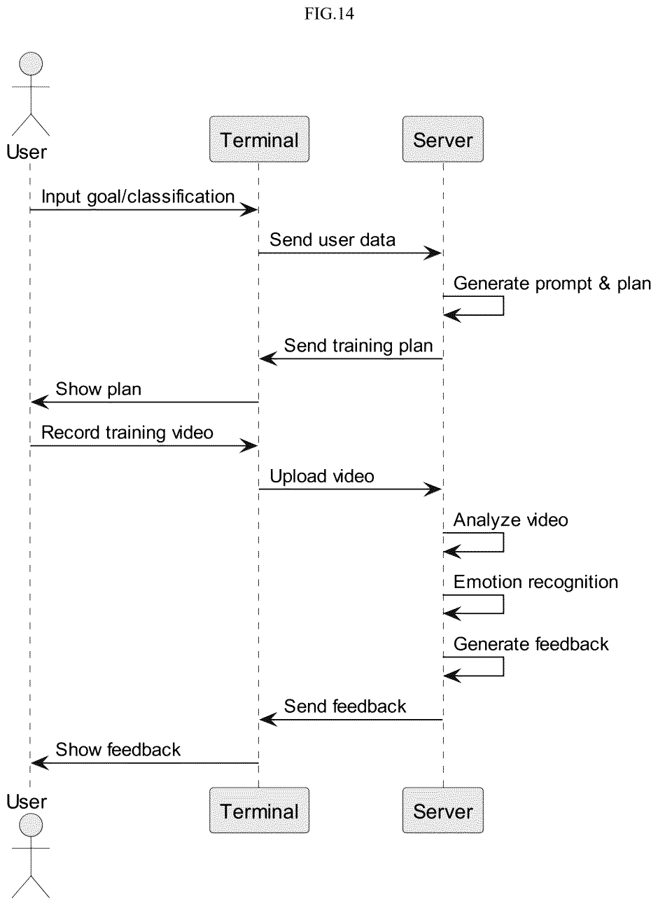

The following describes the processing flow using FIG. 14.

### Step 1:

The user operates the terminal to launch a dedicated application and is presented with an input interface. The user enters their training goal and classification (such as “robot operation” and “efficiency improvement”) into the application.

Input: User interaction and manual input

Output: Goal and classification information transferred from the terminal to the server in a structured data format (e.g., JSON).

### Step 2:

The server receives the goal and classification data from the terminal and records it with a user identifier in the database. The server processes the incoming data and automatically generates a prompt sentence tailored for the generative AI model, such as “Generate a personalized robot operation training plan focusing on efficiency improvement.”

Input: Goal and classification data

Process: The server formats a prompt sentence for the generative AI model

Output: Custom prompt sentence used for training plan generation.

### Step 3:

The server invokes the generative AI model, passing in the generated prompt sentence. The model processes the input and produces a training plan, which includes a training schedule, specific exercises, and stepwise objectives. The server parses and formats the model's output and stores the training plan in the database.

Input: Prompt sentence

Process: The server communicates with the generative AI model and processes the results

Output: Personalized training plan for the user.

### Step 4:

The server sends the personalized training plan to the terminal. The terminal receives the plan data from the server and displays it to the user using a graphical dashboard with readable sections for schedule, exercises, and instructions.

Input: Training plan data

Output: Visually rendered training plan on the user's terminal application.

### Step 5:

The user checks the training plan on the terminal and follows the instructions to perform the assigned activity. The user utilizes the terminal's camera feature to record a video of their training activity (such as themselves operating a robot).

Input: User's physical activity performed according to the training plan

Output: Recorded video file saved on the terminal.

### Step 6:

The terminal compresses and encrypts the recorded video, attaches user and session metadata, and uploads the video to the server via a secure communication protocol.

Input: Video file and metadata

Process: The terminal handles data packaging and secure transfer

Output: Uploaded video and metadata received by the server.

### Step 7:

The server receives the video file and executes a series of data processing tasks: extracting frames using image processing (e.g., OpenCV), extracting movement features with an action recognition model, and comparing user actions against reference motion profiles. The server identifies operation error locations and candidate corrections, saving both analysis data and evaluation results.

Input: Uploaded video file and session metadata

Process: Motion analysis and comparison with reference data

Output: List of detected errors, correction candidates, annotated timestamps.

### Step 8:

The server analyzes the uploaded video with an emotion recognition module, extracting emotional cues from facial expressions, voice, and body language to estimate the user's emotional state during the activity.

Input: Video frames and audio track

Process: AI-powered emotion classification

Output: Classified emotional state appended to the session analysis data.

### Step 9:

The server synthesizes operation error analysis and emotional state, then generates an updated prompt sentence for the generative AI model, such as “Generate stepwise feedback to correct slow arm movement and suggest advice for user frustration.” The model creates personalized feedback, including technical correction advice and motivational or relaxation guidance.

Input: Analysis results and emotional state

Process: Prompt sentence generation and feedback generation by the generative AI model

Output: Structured personalized feedback.

### Step 10:

The server transmits the feedback data to the terminal. The terminal displays the feedback in the application dashboard, clearly segmenting “Correction Points,” “Improvement Suggestions,” and “Motivational Tips.”

Input: Feedback data

Output: Displayed feedback on the user terminal.

### Step 11:

The user reviews the feedback and instructions, adjusts their approach, and undertakes the next training attempt using the suggested corrections and advice. The process, from video recording to feedback, is repeated as needed to enable continuous improvement.

Input: User interpretation of feedback

Output: Improved performance in the next cycle, with new video data produced for further analysis.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

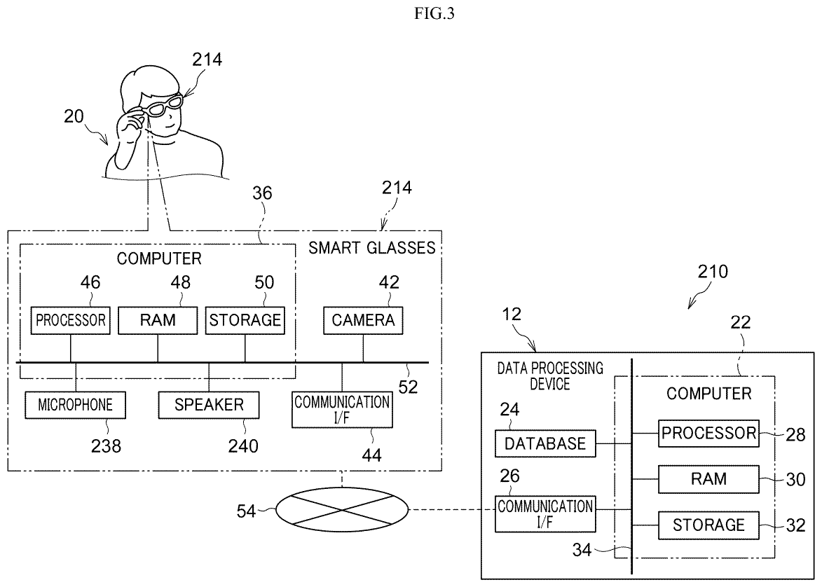

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

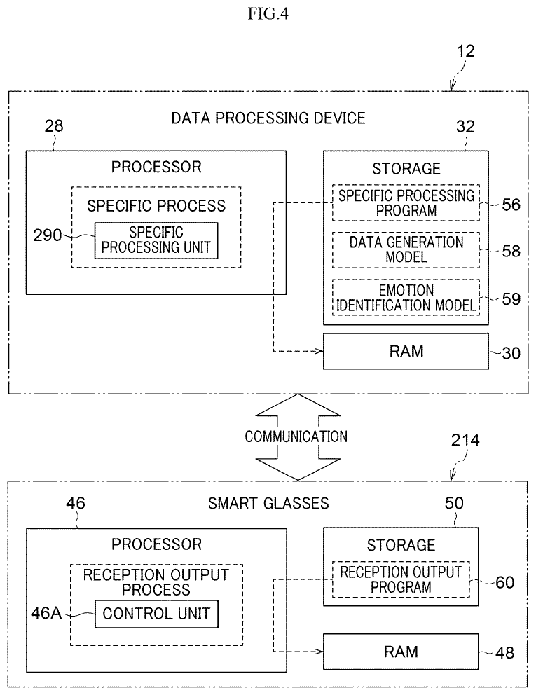

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

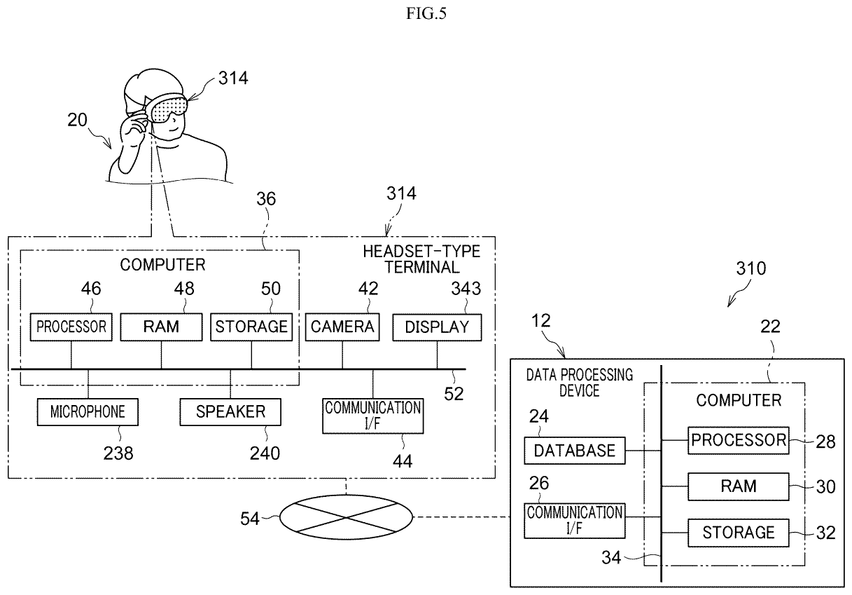

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

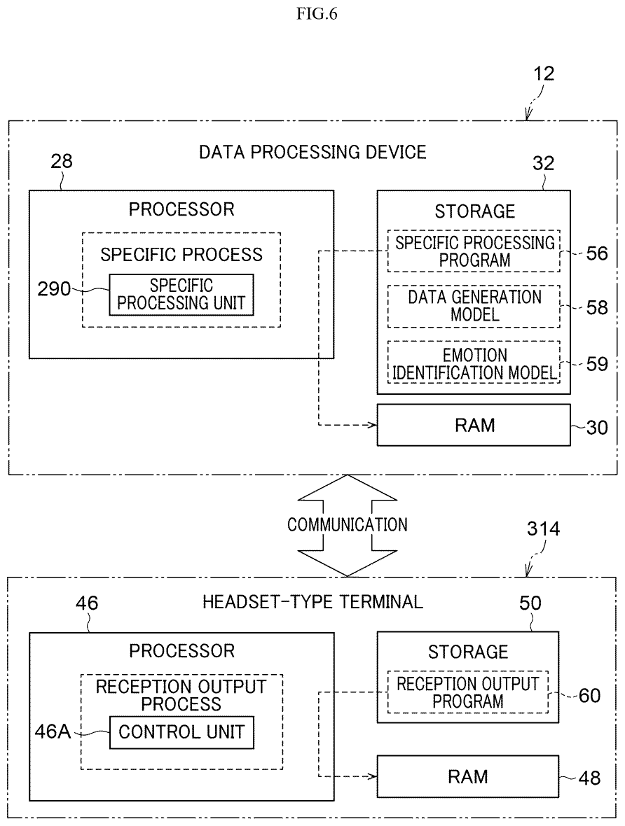

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

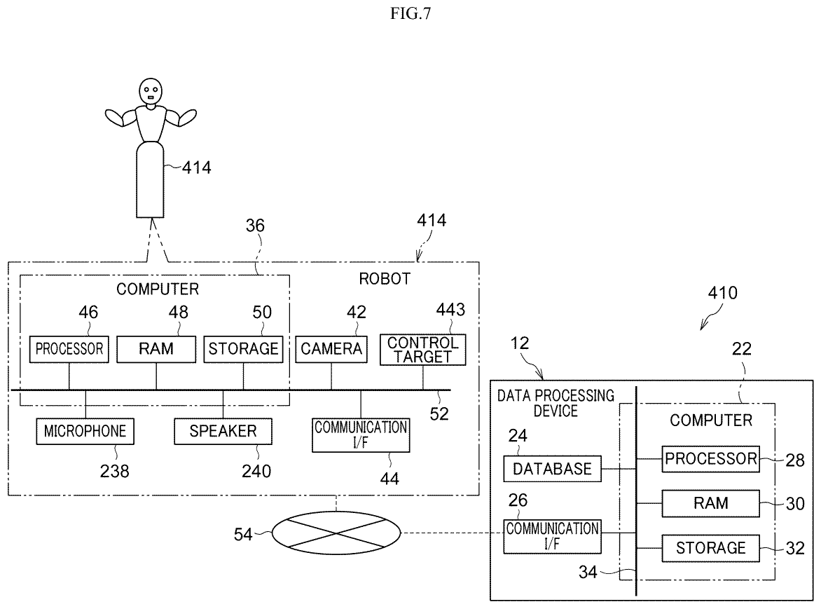

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

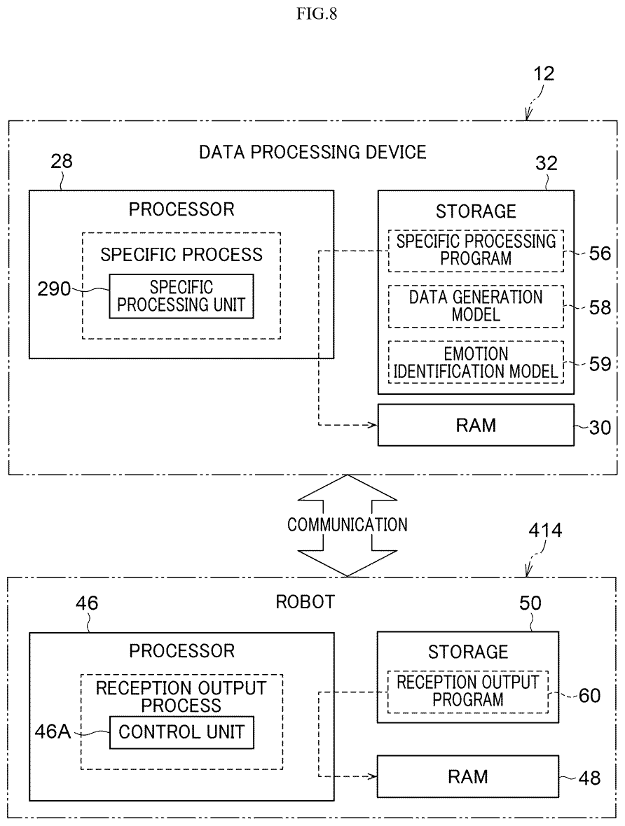

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

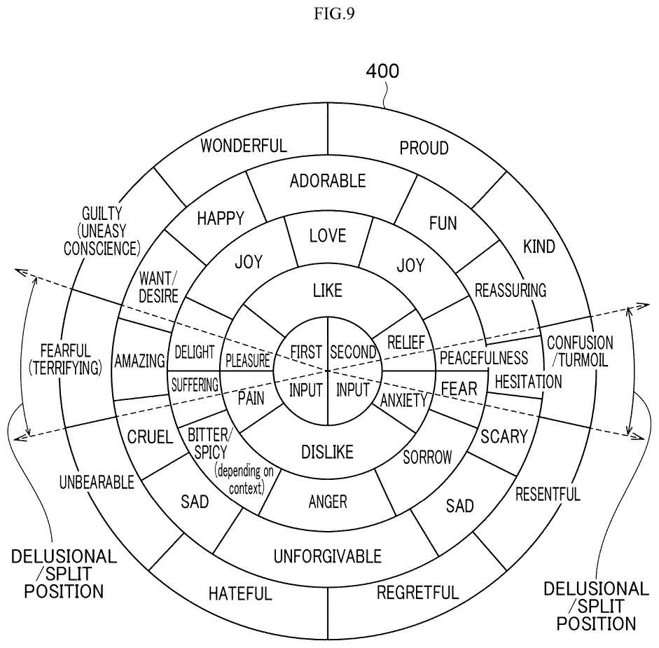

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

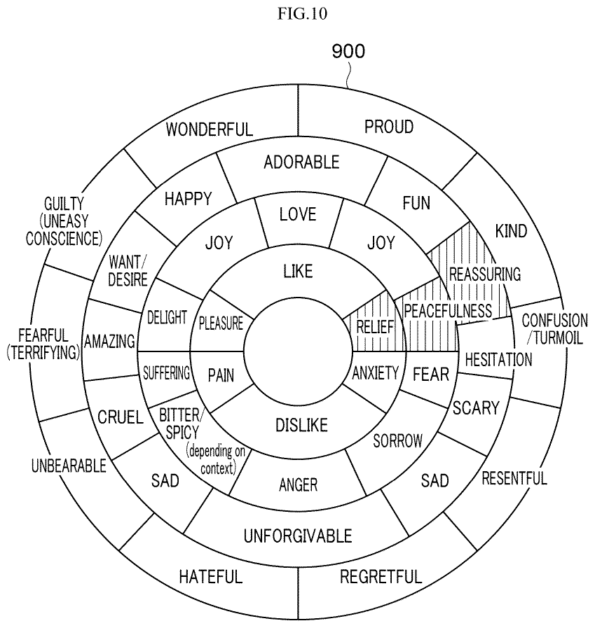

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive activity objective information and activity type information entered by a user through an information input unit;
generate, based on the obtained activity objective information and activity type information and by utilizing associated knowledge information, an instruction sentence for input to a generative artificial intelligence model, and generate training plan information by utilizing the instruction sentence;
obtain motion video information generated by the user and receive transmission of the motion video information through a video capturing and transmission unit;
analyze the transmitted motion video information using an image recognition process and deep learning process, extract user feature information for each temporal image, and compare the extracted feature information to reference information to identify motion errors and correction points; and
provide, via a communication unit, feedback including the identified correction points and improvement content to the user, wherein the feedback contains replay of corresponding video sections and visual annotations.

### (Supplementary 2)

The system according to supplementary 1,
wherein the processor is configured to analyze the motion video information for each temporal image and compare the user feature information with reference behavioral data to determine deviations.

### (Supplementary 3)

The system according to supplementary 1,
wherein the processor is configured to refer to knowledge information sources and motion theory information for generating the instruction sentence to the generative artificial intelligence model and for optimizing the training plan information.

### Application Example 1

### (Supplementary 1)

A system comprising a processor,
wherein the processor is configured to
acquire information input by a user relating to a training objective and task content,
generate a training activity plan based on the acquired information by utilizing a
generative artificial intelligence model, receive video data recorded by the user during an operation or training and transmitted from an external device,
analyze the received video data using an image analysis device and the generative artificial intelligence model to sequentially identify operational errors and correction points, and
present the identified correction points and corresponding concrete improvement methods to the user by utilizing the generative artificial intelligence model.

### (Supplementary 2)

The system according to supplementary 1,
wherein the processor is configured to
analyze the video data in chronological order and evaluate the user's operation by comparison with standard operation criteria.

### (Supplementary 3)

The system according to supplementary 1,
wherein the processor is configured to
optimize the training activity plan based on information resources including accumulated knowledge data and up-to-date theoretical information by means of the generative artificial intelligence model.

### Example 2

### (Supplementary 1)

A system comprising a processor,
wherein the processor is configured to
obtain objective information and category information from a subject through an information acquisition unit,
generate a support plan based on the information obtained through a plan generation unit,
record and transmit activity video information from the subject using a video transmission unit,
analyze the transmitted video information with an information processing apparatus to extract improper aspects and correction points of the activity through an analysis unit,
provide the extracted correction points and improvement methods to the subject through an information presentation unit, and
recognize an emotional state of the subject as basic information and adjust the content provided by the information presentation unit based on the recognized emotional state through an emotion recognition and adjustment unit.

### (Supplementary 2)

The system according to supplementary 1,
wherein the processor is configured to
analyze the video information in time-series units and compare it with reference standard information through the analysis unit.

### (Supplementary 3)

The system according to supplementary 1,
wherein the processor is configured to
optimize the support plan based on information resources including knowledge information and theoretical information, and generate the plan using a generative artificial intelligence model and an internal prompt sentence through the plan generation unit.

### Application Example 2

### (Supplementary 1)

A system comprising a processor,
wherein the processor is configured to
receive user training goals and classification information via an information input device,
generate a training plan using a generative information processing model based on the received information and automatically create a generation instruction sentence for the generative information processing model,
receive recorded content of user training activity from an image information recording and transfer device,
analyze the received recorded content by performing motion analysis and comparison with reference recorded content to identify operation error locations and correction candidates, and
provide the identified correction candidates and specific improvement suggestions to the user, while detecting the user's emotional state and dynamically adjusting the content or method of presenting the improvement suggestions according to the detected emotional state.

### (Supplementary 2)

The system according to supplementary 1,
wherein the processor is configured to
analyze the recorded content in chronological units and compare them with standard motion history for evaluation.

### (Supplementary 3)

The system according to supplementary 1,
wherein the processor is configured to
optimize the training plan based on a professional knowledge base and up-to-date theory information, and further adjust the plan content using emotion analysis results or user response history.

What is claimed is:

1. A system comprising a processor,
wherein the processor is configured to:
receive input information including a user's training goal and type of sport;
generate a training plan based on the received information;
capture and upload a training video of the user performing training according to the training plan;
analyze the uploaded training video to identify errors in the user's movements and points for correction; and
provide the identified correction points and specific methods for improvement to the user.

2. The system according to claim 1, wherein the processor is configured to analyze the user's movements in the training video frame by frame and compare the movements with professional-level performance.

3. The system according to claim 1, wherein the processor is configured to optimize the training plan based on professional expertise and the latest sports theory.
